(19) United States
(12) Patent Application Publication
(10) Pub. No.: US 2025/0238577 A1
(43) Pub. Date: Jul. 24, 2025

(54) AUTOMATED INVENTION SYSTEM

(71) Applicant: Iprova SA, Lausanne (CH)

(72) Inventors: Julian Charles NOLAN, Pully (CH); Nicholas Simon WALKER, Twickenham (GB)

(21) Appl. No.: 19/033,831

(22) Filed: Jan. 22, 2025

(30) Foreign Application Priority Data
Jan. 23, 2024 (GB) 2400890.6

(51) Int. Cl. G06F 30/20

(52) U.S. Cl. CPC G06F 30/20

(57) ABSTRACT

A computer implemented (CI) system for providing user transparency and control regarding an invention generated in response to an input from an operator, the CI system being configured to operate in a first mode and a second mode, the CI system comprising: an interface for receiving the input from the operator and providing an output to the operator; a memory for storing one or more prior art data sources; the interface and memory being coupled to a processor, wherein the processor is configured to receive the input, and based on the input to execute an invention process, the invention process comprising: searching the one or more prior art data sources stored in the memory; and based on the prior art data sources, generating at least one high-level invention concept, with associated invention detail; wherein in the first mode, the CI system provides the high-level invention concept as well as the invention detail as the output and wherein in the second mode the CI system provides the high-level invention concept as an output, such that the user is required to provide the detailed invention.

### CROSS-REFERENCE TO RELATED APPLICATION

This application claims priority to and the benefit of United Kingdom Patent Application No. 2400890.6, filed in United Kingdom on Jan. 23, 2024, the disclosure of which is incorporated herein by reference in its entirety.

### TECHNICAL FIELD

The present disclosure relates to an automated invention generation system and in particular to a computer-implemented system and method for providing user transparency and control regarding a generated invention.

### BACKGROUND

Large language models (LLMs) are a type of artificial intelligence (AI) that use neural networks. They are typically implemented with a deep learning model such as a transformer. A transformer is a type of neural network architecture and is used often for natural language processing tasks. The LLM will receive an input in the form of a text prompt and will output a response in the form of a body of text. The algorithms of an LLM are trained on large sets of text.

LLMs can be improved or adapted for certain tasks through the addition of external tools. These tools can include web searches, database queries, mathematical calculations or even means of running computer codes. An LLM can be configured to choose and call upon any external tool which would be best for answering a text prompt presented to it at a given time. This technique has been utilized in, for example, Toolformer [Schick et al. 2023 ‘Toolformer: Language Models Can Teach Themselves to Use Tools’] and AI tools [Shen et al. 2023 ‘HuggingGPT: Solving AI Tasks with ChatGPT and its Friends in HuggingFace’].

In addition to the above, LLMs can also be configured as software agents whose prompts are correctly configured for them to perform specific functions and to exchange text with other agents. Individual agents can be compiled and organised into a set structure such that each agent will have a specific sub-goal but the overall system can autonomously achieve a goal set by a human user. These frameworks of autonomous LLM agents have been used in AutoGPT (https://github.com/Significant-Gravitas/Auto-GPT) and BabyAGI (https://github.com/yoheinakajima/babyagi).

Given the prevalence of OpenAI LLMs of ChatGPT (https://openai.com/blog/chatgpt) and GPT4 (https://openai.com/gpt-4), more people are using artificial intelligence models like LLMs to aid them in writing code, developing ideas, creating presentations and much more. As the LLMs are trained on vast quantities of data from across the internet-which includes publications, patents and other forms of copyrighted work-the output of an LLM is a complex amalgamation of these data sources. Hence, it is possible that a user is unwittingly plagiarising and could also be inadvertently infringing on the data sources and copyrighted works.

Additionally, these types of AI systems are being implemented in research and development purposes. Whilst this can be useful to companies and research teams in the short-term, in the long-term this can pose problems: such as limiting the creativity of the organization; as well as potentially preventing any form of protection for arising intellectual property (IP) due to the primary creator/inventor arguably being the LLM.

These LLM models have also been used to generate new ideas for innovative technical solutions as per the Applicant's existing products. However due to new regulations and the requirements to be more transparent, there is a need to be able to show the steps the LLM has taken to create a new innovative idea.

It is an object of the disclosure to address one or more of the above-mentioned limitations.

### SUMMARY

According to a first aspect of the disclosure there is provided a computer implemented (CI) system for providing user transparency and control regarding an invention generated in response to an input from an operator, the CI system being configured to operate in a first mode and a second mode, the CI system comprising: an interface for receiving the input from the operator and providing an output to the operator; a memory for storing one or more prior art data sources; the interface and memory being coupled to a processor, wherein the processor is configured to receive the input, and based on the input to execute an invention process, the invention process comprising: searching the one or more prior art data sources stored in the memory; and based on the prior art data sources, generating at least one high-level invention concept, with associated invention detail; wherein in the first mode, the CI system provides the high-level invention concept as well as the invention detail as the output and wherein in the second mode the CI system provides the high-level invention concept as an output, such that the user is required to provide the detailed invention.

For instance, when the CI system is configured in the second mode, the CI system provides only the high-level invention concept as an output but without the invention detail.

Optionally, the CI system further comprises an invention process audit log coupled to the processor such that the CI system records the invention process and the high-level invention concept in the invention process audit log.

Optionally, the input comprises a set of constraints defining an invention scope.

Optionally, the set of constraints comprising one or more of the following: a technical area; a timescale for commercialisation; a cost limit; a novelty requirement.

Optionally, the input further comprises an instruction to configure the CI system into either the first mode or the second mode.

Optionally, the processor comprises a generative artificial intelligence with a large language model configured to spawn a plurality of interacting software agents.

Optionally, the processor further comprises a set of callable software tools.

Optionally, the plurality of interacting software agents are configured to interact with the set of software tools to execute the invention processes.

Optionally, the invention process further comprises finding one or more trigger documents and one or more enabling documents.

For instance, the one or more trigger documents could be documents which disclose insights, such as new scientific findings, on which the invention is based.

For instance, the one or more enabling documents could be documents which disclose or support detailed means by which the invention can be accomplished.

Optionally, the one or more trigger documents and the one or more enabling documents comprise a plurality of invention key sources.

Optionally, the invention key sources comprise one or more of the following: new scientific findings, identified problems, societal or technology trends which are critical to the development of the invention.

Optionally, wherein the high-level invention concept comprises: a problem to be solved; the one or more trigger documents; the one or more enabling documents; and an invention signature.

Optionally, the problem to be solved is generated from a set of problem statements extracted from the one or more trigger documents.

Optionally, the invention signature defines a category of the invention.

Optionally, the category of the invention could be one of either: a component re-use, wherein the invention re-uses a known component for a new functionality; or a component merge, wherein the invention replaces two or more components that each perform a functionality with a single component that can perform each functionality; or a system improvement, wherein the invention improves a system by changing one or more components such that the system can be used in a new operation; or non-obvious change, wherein the invention improves the system through use of distant domain analogy.

According to a second aspect of the disclosure there is provided a method of using the CI system of the first aspect of the disclosure to provide user transparency and control regarding an invention, the method comprising: a user providing to the CI system an input at an interface; a processor receiving the input and executing an invention process comprising: searching one or more prior art data sources that are stored in a memory; and based on the prior art data sources, generating at least one high-level invention concept, with associated invention detail; and the CI system providing an output to the user via the interface in either a first mode or a second mode, wherein in the first mode the CI system provides the high-level invention concept as well as the invention detail as the output and wherein in the second mode the CI system provides the high-level invention concept as the output, such that the user is required to provide the detailed invention.

Optionally, the input comprises a set of constraints defining an invention scope and an instruction to configure the CI system into either the first mode or the second mode.

Optionally, the processor comprises: a generative artificial intelligence with a large language model configured to spawn a plurality of interacting software agents; and a set of software tools configured to interact with the software agents to execute the invention process.

Optionally, the invention process further comprises: finding one or more trigger documents and one or more enabling documents.

Optionally, the high-level invention concept comprises: a problem to be solved; one or more trigger documents; one or more enabling documents; and an invention signature.

Optionally, the one or more trigger documents and the one or more enabling documents are cited in the output to prevent plagiarism by the user.

According to a third aspect of the disclosure there is provided a system and method for preventing plagiarism issues with language-based AI systems, comprising: an interface for receiving the input from the operator and providing an output to the operator; a memory for storing one or more data sources; the interface and memory being coupled to a processor, wherein the processor is configured to receive the input, and based on the input to execute an search process, the search process comprising: searching the one or more data sources stored in the memory; and based on the data sources, generating at least one solution, the solution comprising one or more extracts from one or more data sources; wherein one or more extracts presented to the user that came directly from a given data source is cited and referenced properly.

Optionally, the users are also provided with links to the source used.

It will be appreciated that the system and method of the third aspect may include using and/or providing features as set out in the first aspect and/or second aspect, and can incorporate other features as described herein. Description of the drawings

The disclosure is described in further detail below by way of example and with reference to the accompanying drawings, in which:

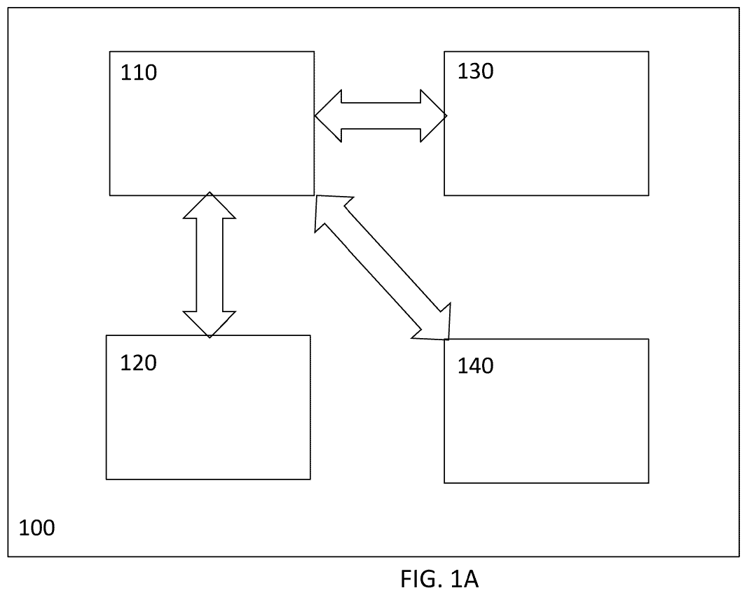

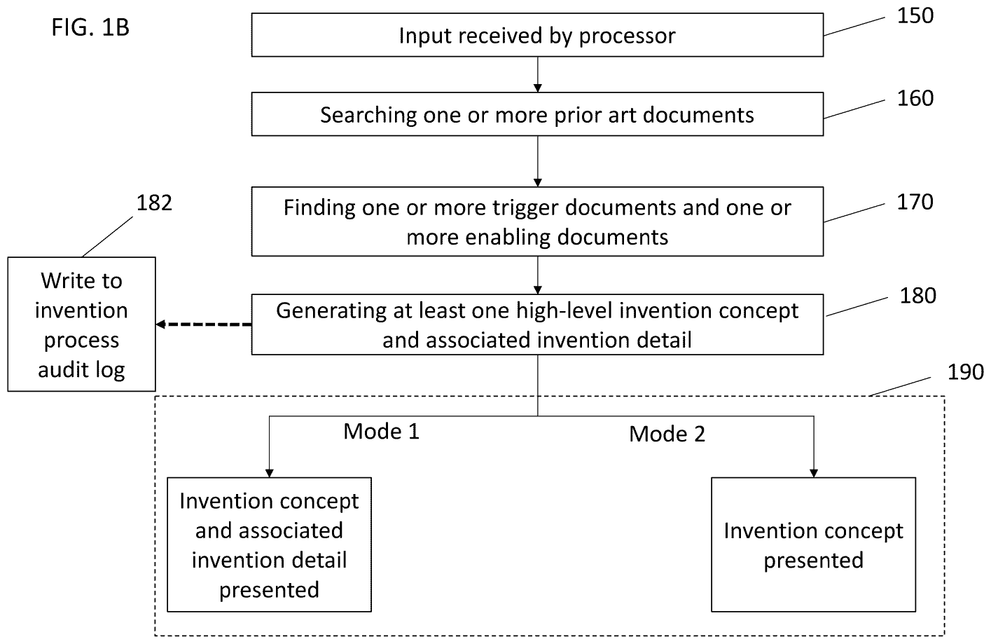

FIG. 1A is a computer implemented system for providing user transparency and control regarding an invention according to the present disclosure;

FIG. 1B is a flow chart of an invention process the computer implemented system of FIG. 1A executes;

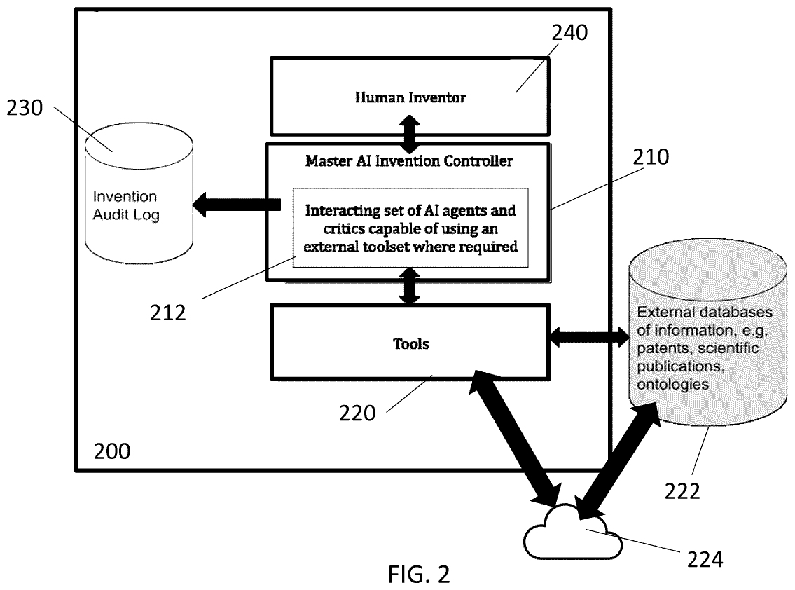

FIG. 2 is a diagram of an example embodiment of the computer implemented system of FIG. 1A;

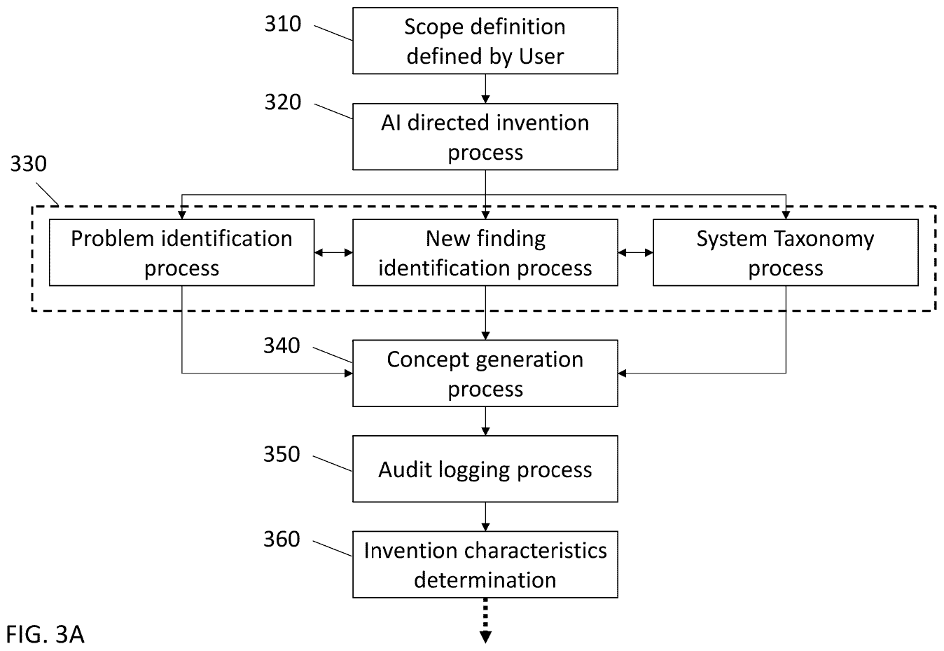

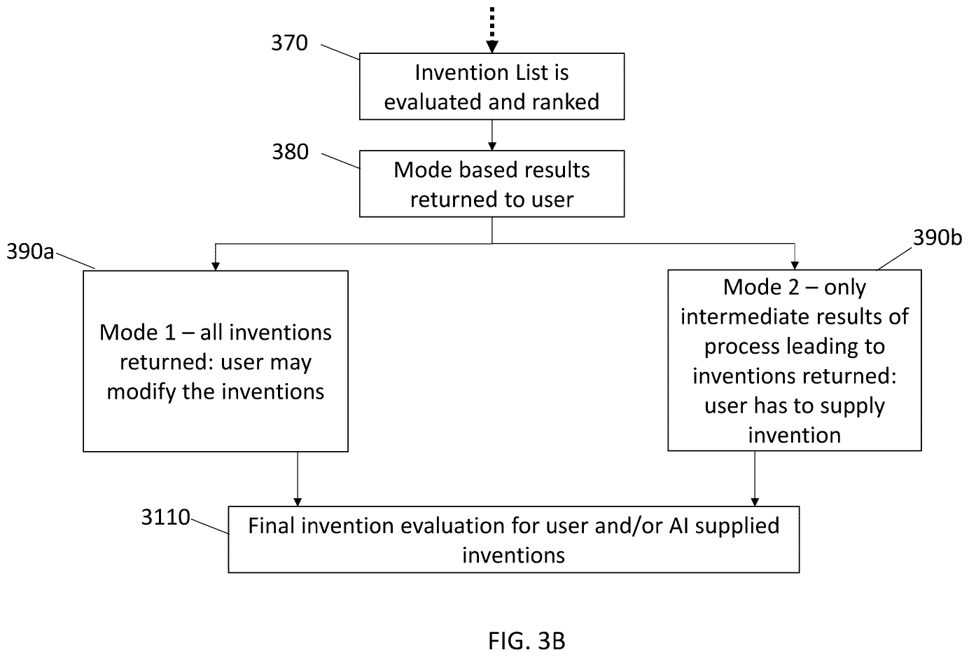

FIGS. 3A and 3B are a flow chart of how an invention concept is generated using the example embodiment computer implemented system of FIG. 2; and

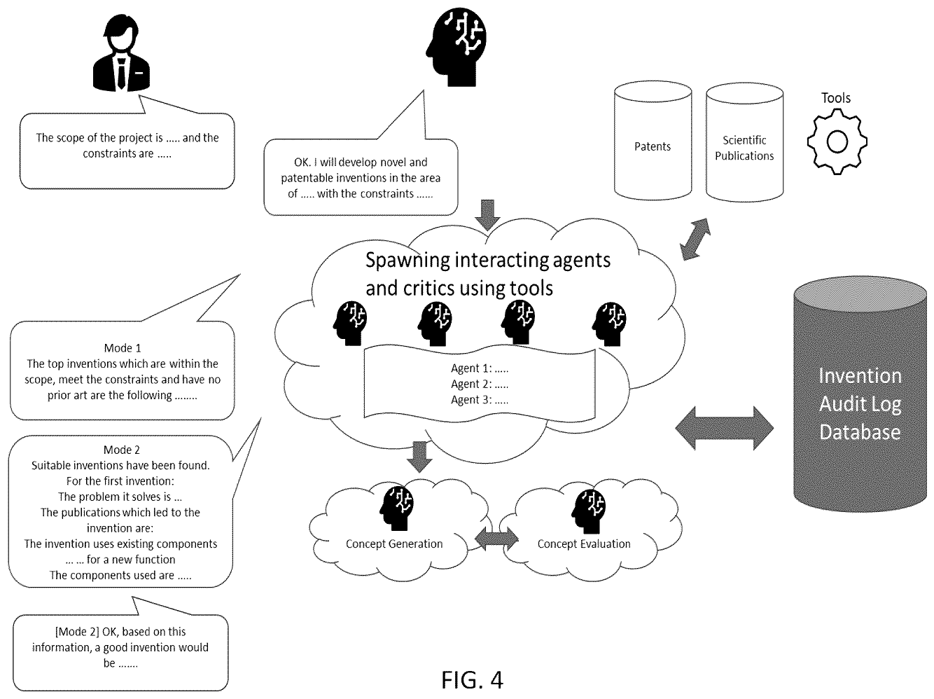

FIG. 4 is a diagram showing a working example of the computer implemented system of FIG. 2 of the present disclosure.

### DESCRIPTION

FIG. 1A is a diagram of a computer implemented (CI) system 100 for providing user transparency and control regarding an invention generated in response to an input from an operator. The CI system 100 is configured to operate in a first mode and a second mode.

The CI system 100 comprises an interface 120 for receiving the input from the operator and providing an output to the operator and a memory 130 for storing one or more prior art data sources. The input received at the interface 120 comprises a set of constraints that define an invention scope. The set of constraints can comprise the following: a technical area; a timescale for commercialization, a cost limit and a novelty requirement. Other constraints can also be included depending on the need of the operator. Examples of such constraints might be: avoiding certain known solutions; avoiding the use of certain technologies; taking account of certain known problems; and so on. The input which is received by the interface 120 further comprises an instruction which configures the CI system 100 into operating in either the first mode or the second mode. Both the interface 120 and the memory 130 are coupled to a processor 110. The processor 110 is configured to receive the input and based on the input execute an invention process. The steps of the invention process can be seen in more detail in FIG. 1B.

FIG. 1B is a flow chart showing the main steps in the execution of an invention process by the processor 110 of CI system 100. At step 150, the input is received by the processor 110 which then based on this input executes the invention process. At step 160, the processor 110 searches the one or more prior art data sources stored in the memory 130. Then, at step 170, the processor 110 finds one or more trigger documents and one or more enabling documents. The one or more trigger documents and one or more enabling documents comprise a plurality of invention key sources. Invention key sources comprise one or more of the following: new scientific findings; identified problems; societal or technology trends which are critical to the development of an invention. Then at step 180, at least one high-level invention concept is generated by the processor 110. Also generated at this step is an associated invention detail. The invention concept comprises a problem to be solved, the one or more trigger documents, the one or more enabling documents and an invention signature. The problem to be solved is generated from a set of problem statements that were extracted by the processor 110 from the one or more trigger documents. An invention signature defines a category for the invention. For example, the invention signature could be a component re-use, wherein the invention re-uses a known component for a new functionality. Another example of an invention signature is a component merge, wherein the invention replaces two or more components that each perform a separate functionality with a single component that can perform all the functionalities. A range of such invention signatures have been identified and other types of invention signature can also be used, such as the following:
1. Component re-use-extend one component so it can now perform a new function.
2. Component merge-extend one component so that that it can now fulfil both its function and the function of another component (remove other component).
3. System remain broadly same but improved through change to specific system component(s)—resolves a problem e.g. when system used in a new scenario.
4. Non-obvious change to system through use of distant domain analogy.

In parallel to step 180, the processor 110 also performs step 182. Returning to the CI system 100, it further comprises an invention process audit log 140 which is also coupled to the processor 110. The CI system 100 is configured in such a way that the steps of the invention process executed by processor 110 are recorded in the invention process audit log 140 along with the invention concept and associated invention detail generated. This functionality is performed at step 182. Finally, at step 190, an output is provided. Depending on which mode the CI system 100 is configured to operate in, the processor 110 will either provide the high-level invention concept as well as the invention detail as the output (mode 1) or the invention concept (mode 2). If the CI system 100 is configured to operate in mode 2, the user is then required to provide the detailed invention.

The processor 110 can comprise a generative artificial intelligence with a large language model (LLM). The LLM is configured to spawn a plurality of interacting software agents. The processor 110 can also comprise a set of software tools wherein the software agents and the software tools are configured to interact with each other in order to execute the invention process. An example embodiment of such a CI system is shown in FIG. 2.

FIG. 2 is a block diagram of an example embodiment of a computer implemented system 200. The CI system 200 is an embodiment of the system of FIGS. 1A and 1B. The system 200 is an AI computer implemented system which utilizes AI models such as large language models (LLMs). The AI system 200 comprises a master invention controller 210 which acts as a processor, a human inventor 440 which is the interface, a toolset 220 comprising external databases of information 222 and a memory or invention audit log 230.

The master invention controller 210 is a generative AI module which is implemented with large language models (LLMs). The master invention controller 210 is configured to spawn multiple software agents (specialized sub-instances of LLMs, including their specified capabilities, task list, memory system and so on) that will interact with each other autonomously with the purpose of conducting and integrating small sub-processes. These interacting agents are collectively called ‘Multiple Interacting AI Agents’ (MIAA) 212. The sub-processes that are performed by the MIAA 212 form part of the overall solution-forming process and are utilized to execute the computer implemented method of the present disclosure.

Some of the sub-processes that the MIAA 212 can perform are:
Examining the scope of invention. A sub-process to analyze the current goal of the project in terms of the scope of invention that the user provided to the system 200. These parameters can include, but are not limited to, technologies, applications and time-scales for the project.
Finding high-quality problems. A sub-process which searches for problems to be solved that are relevant to the scope of invention provided by the user and summarizing these problems.
Finding new research. In this sub-process, an agent of the MIAA will analyze the available scientific research in the external database 222 to uncover key scientific research findings relevant to the scope of invention and the problems to be solved.
Classifying solution approaches. Given the scope of invention and the list of problems to be solved, the AI system 200 will then classify potential solutions into groups that have a similar generic approach to solving the problem.
Detailing a given solution approach. This sub-process will take a given potential solution and break it down into its relevant components. It will methodically work through the problem that is solved with this potential solution and detail all the steps taken along the way.
Examination of the solution. A sub-process which will examine the detailed potential solution provided by the previous sub-process to verify that the potential solution meets the requirements of scope of invention as other implicit requirements. These implicit requirements can include, for example, checking to see if the potential solution is scientifically feasible and whether it is cost-effective.
Rating the solutions. Once potential solutions have been fleshed out, the AI system 200 will rate them based upon a selection of terms such as novelty and time-scale for development. This sub-process will also cross-examine the potential solutions against the existing documentation in the public domain as retrieved from external database 222. This ranked list will be provided to the user via the interface 240 depending upon the mode of operation they selected for the AI system 200 to execute the output in.

The master invention controller 210 and the MIAA 212 are able to call upon and exchange information with a toolset 220. The toolset 220 is a compilation of the different tools the MIAA 212 can call upon whilst executing their sub-processes. The toolset 220 can also call upon external tools 224. Some of the external tools 224 that can be implemented are:
Specialized AI models which can include tools for document summarization, inventiveness score assessment, extraction and summarization of key invention-related elements of the document (if any) such as the new inventive findings, problems or trends, language translation and so on. Such tools can be used to determine if a document contains information that is potentially novel and may provide an insight for an invention. Such tools can also label the parts of the documents which contain this information. The tools work by classifying each part of a document, for example a sentence or a paragraph, with a score for how inventive that part of the document appears to be. These tools are trained with existing text that is known to either be inventive or not.
Document search tools which can be used to find documents that match a specific search query within an external database of information 222. It can also include tools that can conduct an internet search for specific documents.
Document ranking tools which can sort the documents found through searches into an order based on their relevance to the search query applied.
Patent search tools which can be implemented to uncover patent documents in the external databases of information 222 that are most relevant to a potential solution or invention concept that the AI system 200 has developed.

Other tools that can be utilized include calculators and code-running modules.

The master invention controller 210 is also configured to provide and maintain an audit log 230. This audit log 230 acts as a stored memory of all of the processes, agents and tools that the master invention controller 210 implemented which lead it to the invention concept and output provided to the user at interface 240. The audit log 230 also contain details of the communications between the MIAAs 212. The audit log 230 shows clearly how the invention concept was originated by the AI system 200 including the contributions from the user at the interface 240. The audit log 230 can be adapted to store only information pertaining to a specific solution or to many different solutions.

FIGS. 3A and 3B represent a method flow of the operation of the system 200.

In step 310, a user provides to the system 200 the scope of invention. This also includes any constraints that should be applied when analyzing solutions to the problem. These constraints can include: the time-scale for the project to be commercially viable, the budget for the project and any technical areas within the overall project that should be the focus for an innovation. In this step the user will also specify a mode of operation for the processor 210. The processor 210 is configured to operate in a first mode and a second mode, wherein the first mode and the second mode correspond to the presentation of the solution to the user via interface 240

At step 320, the processor 210 comprising an AI model analyzes the project scope provided. A top level agent is spawned by the AI model which will orchestrate the overall procedure, accounting for the scope of invention. For example, step 320 can start with the scope of invention being examined, stored and converted into a full set of constraints against which the solutions found can be evaluated for a match to the project scope.

The process of developing solutions and inventions begins in step 330. There are number of different functionalities performed at step 330 by the AI model. The top-level agent will use a number of strategies to develop an invention. As an example (problem directed invention strategy), it can spawn a problem finding agent whose sub-goal is to identify a list of high-quality, new problems within the project scope for which an innovation should be developed for. This is marked as the problem identification process at step 330. The problem solving agent achieves this sub-goal by selecting a large number of documents relating to the technical area of the scope of invention that have been made publicly available in the last two years. The problem solving agent will extract from these documents any problem statements. In other words, it will identify specific areas of the scope of invention for which a solution needs to be generated. These problem statements are compiled into a list of problems to be solved which are then ranked. The list is ranked according to, for example, how novel the problem to be solved is. The problem solving agent communicates this list back to the top level agent who will then select the highest ranked problem to be solved and spawn a new agent. This new agent is a taxonomy agent which will classify the potential solutions to the problems to be solved into a full taxonomy of generic approaches. This is marked as the system taxonomy process at step 330. These potential solutions could all be directed to a single problem identified or multiple problems that have been identified. For each potential solution in the taxonomy, the taxonomy agent will use the tools in toolset 220 to uncover recent scientific findings relevant to a given approach. For example, the toolset 220 can comprise a number of AI search tools. All potential solutions are then evaluated with relevant findings noted and their inventiveness assessed. This can be seen by the new finding identification process at step 330. Any new findings that are judged to satisfy the scope of invention are added to a list of ‘triggers’ for a concept. The highest ranked potential solutions and the list of triggers is then returned to the top-level agent. The highest ranked potential solutions are also stored in an invention log.

Based upon the highest ranked problem, its potential solutions and list of triggers, an invention concept is generated in step 340. This invention concept will address the highest ranked problem(s) to be solved using a chosen solution approach from the taxonomy that satisfies the scope of invention and utilizes the newest scientific findings from the ‘triggers’ list. The invention concept will then be parsed through the set of constraints associated with the scope of the project. All elements of the invention concept will be evaluated for whether they are physically possible and if they are capable of being enabled. The invention concept will also be cross-referenced with documents related to the technical area which have been found using, for example, a patent search tool in toolset 220 to ensure that this invention concept is not excluded already. The patents search tool can access the external database 222 of the toolset 220. All the sub-steps of this stage of the method of operating the system are stored in the audit log in step 350. All the documents that have been used in developing the invention concept will be stored in a reference log. These documents in the reference log can also be referred to as invention key sources. The invention key sources can comprise new scientific findings, identified problems, societal or technology trends, which are critical in the development of the invention, presented as extracted summaries of the key text elements along with a link to the original source.

In step 360, generic characteristics of the invention concept are found. These characteristics comprise the invention signature as well as specific parameters associated with the invention signature. The invention signature is a description of the type of invention concept being provided. For example, the invention signature could indicate that the invention concept involves re-using components in some new way to perform a new function which solves the problem to be solved. Parameters of this signature would be the components being re-used and the new functionality. The invention signature could also indicate whether the solution lies in the replacing of a plurality of components with a single component that performs all the functions of the removed components thus simplifying the structure of the device. Parameters of this invention signature would be the components to be replaced. A small number of invention signatures and their parameters are included in the system and can be compared to the generated invention to determine which is most applicable.

Steps 330 through 360 can result in more than one invention concept being generated. For example, for a given invention concept to be generated, it is likely that a plurality of initial inventions will also need to be explored. This may result in several final inventions which pass through steps 330 to 360.

In step 370, the AI model will evaluate and rank the invention concepts if more than one concept is provided. The ranking is based on how well each invention concept satisfies the scope of invention.

At step 380, an output is compiled for the user. The output that is compiled depends upon the mode of operation that was selected by the user in step 310. If the first mode was selected, then the output will be configured to present the invention log. The user can then select one of the potential solutions from the invention log to develop and refine further. If the second mode is selected, then the audit log containing only certain limited elements of the process leading to the invention concept and generic representations are presented. The user then can use this information to arrive at an embodiment of the solution themselves. The elements from the audit log that can be presented to the user in the second mode may include: the problem being addressed, the ‘trigger’ documents associated with the solution, the enabling documents associated with the solution and the invention signature. The second mode of operation should be selected if a user is interested in developing a solution that will have protectable intellectual property.

In step 3110, the system 200 will compile the reference log to present to the user. The audit log is also fully compiled and stored which can also be accessed by the user if they want to.

FIG. 4 is a diagram showing how the AI system 200 of FIG. 2 interacts with a human user.

The AI system 200 is configured to receive a text prompt outlining a scope of invention which is provided by a human user. The AI system 200 will return one or more generated solutions for the scope of invention. The AI system 200 has two modes which it is configured to operate in: a first mode and a second mode. The user selects which mode when they provide the scope of invention. During the first mode of operation, the AI system 200 is configured to present the full generated invention concept. In this mode, it may present a ranked list of fully completed solutions for the user to select from. The second mode configures the AI system 200 to present only the generic characteristics of the generated invention concept. As such, the user will be required to use their own creative input to fully arrive at the invention.

The AI system 200 uses a combination of generative AI and AI tools to adjust the output of the system through further, optional modifications. For example, one modification is that the AI system 200 can also be configured to present the user with ‘Invention Key Sources’. This is a list of sources that have been collected by the AI system 200 which are critical to the development of the solution generated including, but not limited to, new scientific findings, identified problems and societal or technology trends. The AI system 200 will provide the user with an extracted text summary of each Invention Key Source as well as a link to the original source for the user to investigate in further detail themselves. Another potential modification is that the AI system 200 can also be configured to produce an ‘Invention Signature’ which details one of a limited number of invention type descriptions, along with optional parameters detailing the signature. Types of Invention signature include, but are not limited to, a ‘component re-use’ signature or a ‘component merge’ signature. The component re-use signature indicates to the human user that a component of a given infrastructure or configuration can be reutilized to perform a new function in addition to the function it currently serves thus solving the problem that was originally presented to the AI system 200. The component merge signature indicates to the human user that several components in the pre-existing infrastructure or configuration for a device can be replaces by a single component whilst still maintaining the devices primary functions.

The AI system 200 is also configured to provide and maintain an invention audit log 230. This invention audit log 230 is a documentation of all of the processes, agents and AI tools that the master invention controller 210 implemented which lead it to the solution and the response provided to the user. It will also contain details of the communications between different agents that have been implemented. The invention audit log 230 is a product of the AI system 200 which will be critical in cases where the computer implement method and system of the present disclosure is being used as part of the research and development team of a company or organization. The invention audit log 230 shows clearly how the solution was originated by the AI system 200 and therefore the actual contribution of the master invention controller 210 to the solution or invention can be quantified. The invention audit log 230 can be adapted to store only information pertaining to a specific solution or to many different solutions. The invention audit log 230 can also store any human intervention or human inputs that the user contributes to the creative and/or innovation process in developing the solution.

The following represents an example of the operation of the AI system 200 operating in the second mode, where the human user is prompted to make the inventive step. The text visible to the human user in this mode is indicated in underline. Additional text which would be visible to the human user with the system operating in the second mode is shown in italics.

### Example Start:

Human user: The scope of the project is future mobile phones, and the timescale is 3-5 years. Inventions should provide new useful functionality but add very little cost of the phone.

Top level AI Agent: OK. I will develop novel and patentable inventions in the area of “future mobiles phones”. Evaluation criteria are that the inventions can be implemented in the 3 to 5 year timescale and the costs of any additional elements should be low.

I will start the invention process using the problem-driven approach to find surprising new problems.

Spawning Problem Selection Agent with scope: “future mobile phones” and criteria: “most surprising”.

Problem Selection Agent: Hello, Problem Selection Agent here. I will find problems in the area of “future mobile phones” and select according to their novelty and surprisingness.

//Internal prompt for sub agent

Invoking tool: ‘Problem Selection’ for time scale 0-2 years and query ‘mobile phones or cellphone or smartphone’ and put the results in List 1

[problem selection tool returns a list of problems found in documents returned by the query in documents published within the last two years, clustered into similar tools and with a summarized format for the problem text returned.] List 1 returned

Invoking tool: ‘Problem Selection’ for time scale 2-10 years and query ‘mobile phones or cellphone or smartphone’ and put the results in List 2

[problem selection tool returns a list of problems found in documents returned by the query in documents published within the times 2 years ago to 10 years ago, clustered into similar tools and with a summarized format for the problem text returned.] List 2 returned

Invoking tool ‘Filter list’ with List 1 filtered by List2 and put the results in List 3.

[Filter list tool returns the problems in list 1 with any similar problems found in list2 removed]—List 3 returned

Invoking tool ‘Text Classification and Ranking’ with label ‘Surprisingness’ on List 3.

[Classification tool classifies all the problems in List 3 with the label ‘Surprisingness’, sorts the list into order and returns the top problem]

//end of internal prompt for subagent

The most surprising new problem is: “As smartphones become thinner it is increasingly difficult for users to pick them up from a flat surface”

Top level AI Agent: Thanks Problem Selection Agent. I will now spawn a Mechanism Taxonomy Agent to find all the possible general mechanisms which might address this problem.

Spawning Mechanism Taxonomy Agent with problem “As smartphones become thinner it is increasingly difficult for users to pick them up from a flat surface”. The smartphone and/or the flat surface can be modified.

Mechanism Taxonomy Agent: Hello, Mechanism Taxonomy Agent here, I will generate a taxonomy of the general mechanisms which might be used to solve the problem: “As smartphones become thinner it is increasingly difficult for users to pick them up from a flat surface”. I understand the smartphone and/or the flat surface can be modified.

//Internal Prompt for Sub Agent

The derived problem is that picking up a thin flat object from a flat surface is hard for human fingers. Here the thin flat object is a smartphone.

//end of internal prompt for subagent

The taxonomy is:
1: Make the thin object thicker so that it can be picked up more easily.
1.1: Temporarily deploy an extendable ‘edge’ or structure out of the thin object which can be gripped by the user and then retracted, bringing the user's fingers to the edge of the original thin object.
2: Raise the thin object above the surface so that it can be picked up more easily.
2.1: Get the thin object to ‘jump’ up from the surface at the correct time so that it can be picked up more easily.
2.1.1: Integrate spring driven actuators in the smartphone or surface

which enables the thin object to spring up from the surface.
2.1.2: Create a momentary propulsive force using air movement between the thin object and the surface, e.g. drone-like propellers on the smartphone or air jets out of the flat surface.
2.1.3: Create a means of slightly depressing and extending the flat surface which can be activated and propels the thin object into the air, e.g. an actuated diaphragm.
2.1.4: Create a momentary magnetic repulsion between the thin object and the flat surface e.g. using an electromagnetic field.
2.2: Make the thin object continuously float above the surface so that it can be picked up more easily.
2.2.1: Create a continuous electromagnetic repulsion between the thin object and the flat surface e.g. using permanent magnets.

Top level AI Agent: Thanks Mechanism Taxonomy Agent. I will explore all these approaches in turn.
2.1.4: Create a momentary magnetic repulsion between the thin object and the flat surface e.g. using an electromagnetic field.

I will spawn a New Findings Agent with the mechanism “Create a momentary magnetic repulsion between the smartphone and a flat surface e.g. using an using an electromagnetic field.”

New Findings Agent: Hello, New Findings Agent here. I will search for new findings for the mechanism: Create a momentary magnetic repulsion between the smartphone and a flat surface e.g. using an electromagnetic field.”

//Internal prompt for sub agent

I will use the new research findings search tool and the query “generation of electromagnetic field and smartphone” ranked by inventiveness and within the last 2 years and returned as list 4.

[new research findings search tool returns a list of extracted summarised description of newly found abilities and the link to the original documents, ranked by inventiveness]-returns List 4.

//end of internal prompt for subagent

The ranked list of top 10 new findings is:
1. Magnetic levitating phone stand: Electromagnets are used to levitate a phone stand for retail display [https://virtualongroup.com/levitation-devicefloating-display/]
0 . . .

Top level AI Agent: Thanks New Findings Agent.

I will spawn a System Components Agent with the system: ‘smartphone’ and the ability: ‘generation of magnetic field’.

System Components Agent: Hello, System Components Agent here. I will generate a supported list of components from the system: ‘smartphone’ with the ability: ‘generation of magnetic field’.

//Internal prompt for sub agent

The following is a hierarchical listing of the components of smartphones:
1. Touch screen display
17. Transmitter/receiver
27. Charging coil

I will invoke the Technical Capability Tool with this list of components to determine if any component can generate a magnetic field.

[Technical Capability Tool uses a knowledge graph to find the abilities of each component and searches to see if they can generate a magnetic field]

//end of internal prompt for subagent

The following components have a capability to generate a magnetic field:
17. Transmitter/receiver [https://www.nature.com/articles/s41598-023-31407-z]
27. Charging coil

[https://www.wirelesspowerconsortium.com/about/about-wpc]

Top level AI Agent: Thanks System Components Agent.

I will spawn a New Concept Generation Agent with:

Problem: “As smartphones become thinner it is increasingly difficult for users to pick them up from a flat surface”.

Mechanism: “Create a momentary magnetic repulsion between the smartphone and a flat surface e.g. using an electromagnetic field.”

Information:
1. Magnetic levitating phone stand: Electromagnets are used to levitate a phone stand for retail display.
2. Smartphones include a Charging coil which can act as an electromagnet.

New Concept Generation Agent: Hello, New Concept Generation Agent here. I will generate new concepts addressing the problem, employing the mechanism and using the background information.

//Internal prompt for sub agent

//end of internal prompt for subagent

The new concept is:

Charging Coil Levitation for Smartphone Pick-up.

Detect when a user is close to a smartphone which is resting on a wireless charging mat and energise the coils in both the smartphone and charging mat correctly so that an electromagnetic repulsion is created between the coils, levitating the phone into the air where the user can easily pick it up. The Smartphone synchronises with the charging mat, e.g. using Bluetooth.

Top level AI Agent: Thanks New Concept Generation Agent.

I will classify the new concept according to its invention signature using the signature classification AI tool.

[signature classification AI tool takes the problem, mechanism, background information and new concept and classifies it into an invention type]

Invention type is ‘Component re-use’. Component is ‘Charging Coil’.

I will evaluate all the generated inventions and rank them using the Concept Evaluation Tool and return the ranked list as List 5.

[Concept Evaluation Tool takes all the new concepts generated in the course of the invention process and evaluates them according to the criteria including checking against prior art and returns a ranked list of inventions meeting the criteria]—returns list 5.

An invention has been found which meets the criteria.

Charging Coil Levitation for Smartphone Pick-up.

Detect when a user is close to a smartphone which is resting on a wireless charging mat and energise both the coils correctly so that an electromagnetic repulsion is created between the coils, momentarily levitating the phone into the air where the user can easily pick it up. The Smartphone synchronises with the charging mat, e.g. using Bluetooth.

Addresses scope: Yes

Criteria low additional cost: Yes

Criteria timescale 3-5 years: Yes

Prior art: No blocking prior art found

The information associated with this invention is:

Problem: “As smartphones become thinner it is increasingly difficult for users to pick them up from a flat surface”.

Information:
1. Magnetic levitating phone stand: Electromagnets are used to levitate a phone stand for retail display. [https://virtualongroup.com/levitation-devicefloating-display/]
2. Smartphones include a Charging coil which can act as an electromagnet. [https://www.wirelesspowerconsortium.com/about/about-wpc]

Invention type: ‘Component re-use’. Component is ‘Charging Coil’.

### End of Example

The computer implemented method as described by the present disclosure of utilizing an automated system such as an AI model with LLMs to aid in research and development is advantageous for several reasons. Firstly, this system allows for human intervention and innovation. This will allow companies and organizations who wish to implement this method and system to obtain solutions which will still be a protectable form of IP.

Secondly, the method and system of the present disclosure provides an audit log which details how it has been used and how it arrived at the proposed solutions. As such, this audit log can be used comparatively with the route taken by the user to show the creative input and expression of the user.

Finally, the method and system of the present disclosure also overcomes the present plagiarism issues with many language-based AI systems. All information presented to the user that came directly from a given source is cited and referenced properly. The users are also provided with links to the source used.

A skilled person will therefore appreciate that variations of the disclosed arrangements are possible without departing from the disclosure. Accordingly, the above description of the specific embodiments is made by way of example only and not for the purposes of limitation. It will be clear to the skilled person that minor modifications may be made without significant changes to the operation described.

1. A computer implemented (CI) system for providing user transparency and control regarding an invention generated in response to an input from an operator, the CI system being configured to operate in a first mode and a second mode, the CI system comprising:
an interface for receiving the input from the operator and providing an output to the operator;
a memory for storing one or more prior art data sources;
the interface and memory being coupled to a processor, wherein the processor is configured to receive the input, and based on the input to execute an invention process, the invention process comprising:
searching the one or more prior art data sources stored in the memory; and
based on the prior art data sources, generating at least one high-level invention concept, with associated invention detail;
wherein in the first mode, the CI system provides the high-level invention concept as well as the invention detail as the output and wherein in the second mode the CI system provides the high-level invention concept as an output, such that the user is required to provide the detailed invention.

2. The CI system of claim 1, wherein the CI system further comprises an invention process audit log coupled to the processor such that the CI system records the invention process and the high-level invention concept in the invention process audit log.

3. The CI system of claim 2, wherein the input comprises a set of constraints defining an invention scope.

4. The Cl system of claim 3, wherein the set of constraints comprising one or more of the following:
a technical area;
a timescale for commercialisation;
a cost limit;
a novelty requirement.

5. The CI system of claim 3, wherein the input further comprises an instruction to configure the CI system into either the first mode or the second mode.

6. The CI system of claim 1, wherein the processor comprises a generative artificial intelligence with a large language model configured to spawn a plurality of interacting software agents.

7. The Cl system of claim 6, wherein the processor further comprises a set of callable software tools.

8. The CI system of claim 6, wherein the plurality of interacting software agents are configured to interact with the set of software tools to execute the invention processes.

9. The Cl system of claim 1, wherein the invention process further comprises finding one or more trigger documents and one or more enabling documents.

10. The CI system of claim 1, wherein the one or more trigger documents and the one or more enabling documents comprise a plurality of invention key sources.

11. The CI system of claim 10, wherein the invention key sources comprise one or more of the following: new scientific findings, identified problems, societal or technology trends which are critical to the development of the invention.

12. The CI system of claim 1, wherein the high-level invention concept comprises:
a problem to be solved;
the one or more trigger documents;
the one or more enabling documents; and
an invention signature.

13. The CI system of claim 1, wherein the problem to be solved is generated from a set of problem statements extracted from the one or more trigger documents.

14. The CI system of claim 1, wherein the invention signature defines a category of the invention.

15. The CI system of claim 14, wherein the category of the invention could be one of either:
a component re-use, wherein the invention re-uses a known component for a new functionality; or
a component merge, wherein the invention replaces two or more components that each perform a functionality with a single component that can perform each functionality; or
a system improvement, wherein the invention improves a system by changing one or more components such that the system can be used in a new operation; or
non-obvious change, wherein the invention improves the system through use of distant domain analogy.

16. A method of using the CI system of claim 1 to provide user transparency and control regarding an invention, the method comprising:
a user providing to the CI system an input at an interface;
a processor receiving the input and executing an invention process comprising:
searching one or more prior art data sources that are stored in a memory; and
based on the prior art data sources, generating at least one high-level invention concept, with associated invention detail; and
the CI system providing an output to the user via the interface in either a first mode or a second mode,
wherein in the first mode the CI system provides the high-level invention concept as well as the invention detail as the output and wherein in the second mode the CI system provides the high-level invention concept as the output, such that the user is required to provide the detailed invention.

17. The method of claim 16, wherein the input comprises a set of constraints defining an invention scope and an instruction to configure the CI system into either the first mode or the second mode.

18. The method of claim 16, wherein the processor comprises:
a generative artificial intelligence with a large language model configured to spawn a plurality of interacting software agents; and
a set of software tools configured to interact with the software agents to execute the invention process.

19. The method of claim 16, wherein the invention process further comprises:
finding one or more trigger documents and one or more enabling documents.

20. The method of claim 16, wherein the high-level invention concept comprises:
a problem to be solved;
one or more trigger documents;
one or more enabling documents; and
an invention signature.

21. The method of claim 16, wherein the one or more trigger documents and the one or more enabling documents are cited in the output to prevent plagiarism by the user.

22. A system for preventing plagiarism issues with language-based AI systems, comprising:
an interface for receiving the input from the operator and providing an output to the operator;
a memory for storing one or more data sources;
the interface and memory being coupled to a processor, wherein the processor is configured to receive the input, and based on the input to execute an search process, the search process comprising:
searching the one or more data sources stored in the memory; and
based on the data sources, generating at least one solution, the solution comprising one or more extracts from one or more data sources;
wherein one or more extracts presented to the user that came directly from a given data source is cited and referenced properly.

23. The system of claim 22, wherein the users are also provided with links to the source used.
